(19) United States
(12) Patent Application Publication
(10) Pub. No.: US 2010/0008112 A1
(43) Pub. Date: Jan. 14, 2010

(54) INTERPHASE TRANSFORMER

(76) Inventors: Frank Z. Feng, Loves Park, IL (US); Debabrata Pal, Hoffman Estates, IL (US); Steven Schwitters, Rockford, IL (US)

Correspondence Address: CARLSON, GASKEY & OLDS, P.C., 400 WEST MAPLE ROAD, SUITE 350, BIRMINGHAM, MI, 48009, US

(21) Appl. No.: 12/169,785

(22) Filed: Jul. 9, 2008

(51) Int. Cl. H02M 7/42

(52) U.S. Cl. 363/64; 363/141

(57) ABSTRACT

Three single-phase interphase transformers are connected to a three-phase transformer. The three single-phase interphase transformers each contain a component for efficiently dissipating heat.

### BACKGROUND OF THE INVENTION

The present invention relates to the construction and use of an interphase transformer in a three-phase power converter.

Some applications using a three-phase power inverter, such as aircraft power systems, require cleaner output power (i.e. output power with less harmonic noise) than a stand alone three-phase inverter can provide. In such a system, it is often necessary to couple an interphase transformer to the three-phase inverter to ensure such a power quality.

In cases where standard three-phase power does not meet the required power quality, interphase transformers are used to further condition the power before the three-phase inverter outputs the power. Currently it is known in the art to connect each phase of a three-phase interphase transformer to a corresponding phase of the three-phase inverter in order to ensure that the desired power quality is achieved. It is also known to utilize a single-phase interphase transformer to ensure that desired current properties are maintained in a three-phase power inverter.

It is known that electrical power systems, and specifically power inverters and interphase transformers in the power systems, generate waste heat during their operation. This heat, if not properly managed, can result in electrical component failure, leading to frequent repair and replacement of the electronic components. The known three-phase interphase transformers are inefficient at dissipating the generated waste heat since they have a relatively small exposed surface area. Methods for cooling and removing heat from the system are known and used in the art, however, the currently known methods have several drawbacks.

Typical systems for removing heat from an interphase transformer have employed fans as well as vents which blow air or other gasses over the electronic components, thereby cooling them. This process results in several drawbacks which make it undesirable for aircraft use or for other uses where space is a known constraint. In addition to the space requirements, a fan-cooled system has moving parts requiring servicing on a more frequent basis. Such servicing adds to the maintenance costs, as well as reducing the time the inverter can be in service.

Another solution used in some three-phase interphase transformer systems involves a physical heat sink which draws the heat away from the interphase transformer and allows the heat to dissipate. Such a system can use water cooling, gas cooling, or other systems known in the art to cool the heat sink and facilitate the dissipation of heat. One known system using this solution draws heat away from the three-phase interphase inverter by using water cooled heat sinks. The three-phase interphase transformer has one phase attached to each phase of the three-phase power inverter. The heat sinks communicate the heat from the three-phase inverter and the interphase transformer away from the core and the windings. The heat sink is then cooled using either gas or liquid cooling.

The above described systems are larger than desirable, especially when considering an aircraft implementation. Additionally the systems described are complex and can require frequent maintenance and replacement resulting in less operational time and greater expenditures.

### SUMMARY OF THE INVENTION

Disclosed is a three-phase power inverter connected to three single-phase interphase transformers. The single-phase interphase transformers each comprise a heat dissipation component and can be connected to a high frequency current.

These and other features of the present invention can be best understood from the following specification and drawings, the following of which is a brief description.

### BRIEF DESCRIPTION OF THE DRAWINGS

FIG. 1 illustrates an airplane with the three-phase inverter of this disclosure implemented in the power supply system.

FIG. 2 illustrates a standard three-phase inverter with three single-phase interphase transformers attached.

FIG. 3 illustrates a heat/electrical winding around a core of a single-phase interphase transformer according to one embodiment of this application.

FIG. 4 illustrates a heat winding and an electrical winding around a core of a single-phase interphase transformer according to one embodiment of this application.

FIG. 5A illustrates a cross section of a tubular member of a single layer heat/electrical winding.

FIG. 5B illustrates a cross section of a tubular member of a multi layer heat winding.

FIG. 6 illustrates a cutout view of a section of a core with a heat winding according to an embodiment of this invention.

### DETAILED DESCRIPTION

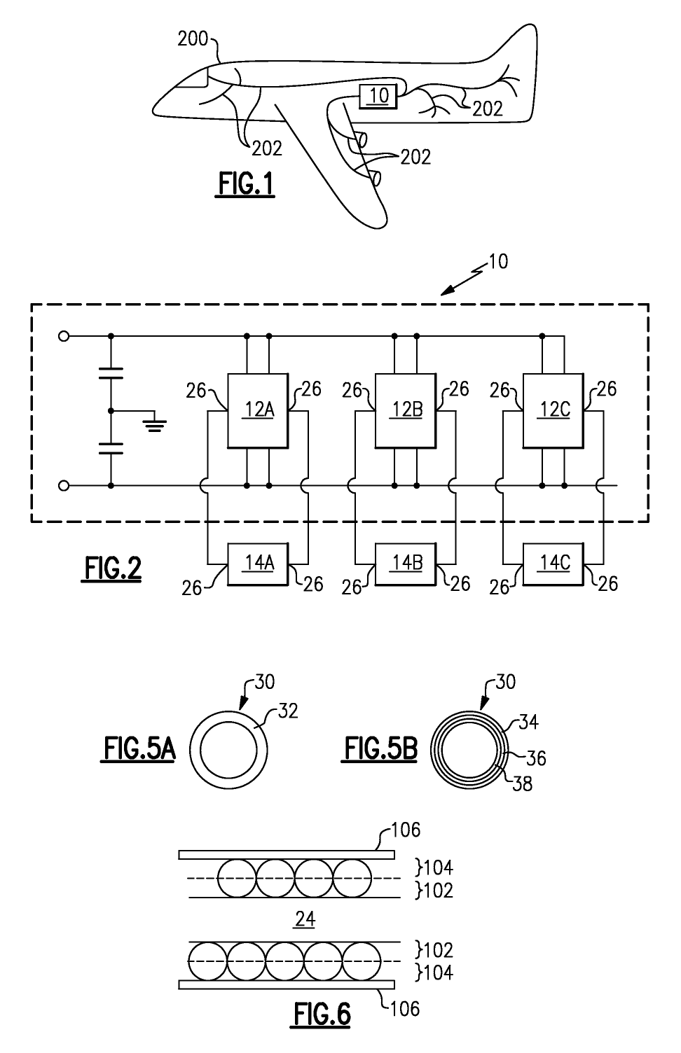

FIG. 1 shows a simplified drawing of an aircraft 200. The aircraft 200 has a three-phase power system 202 which is capable of generating three-phase power using the rotation of a jet turbine engine or another source. Three-phase power is then distributed throughout the plane to onboard electronic equipment. In order for the three-phase power to be utilized by the plane's onboard electronics it must first be sent through a three-phase power inverter 10. In FIG. 1 the three-phase power inverter 10 is illustrated as being in the main body of the plane, however it is known that the three-phase power inverter 10 may be located anywhere in the electrical system between the power source and the equipment which needs the power to be conditioned.

FIG. 2 illustrates a simplified standard three-phase inverter 10 with three single-phase interphase transformers 14 A-C attached. Each of the three single-phase interphase transformers 14 A-C ensure that the three-phase power inverter output of the corresponding phase meets the required power quality. This allows the output power to be conditioned beyond the capabilities of the three-phase power inverter.

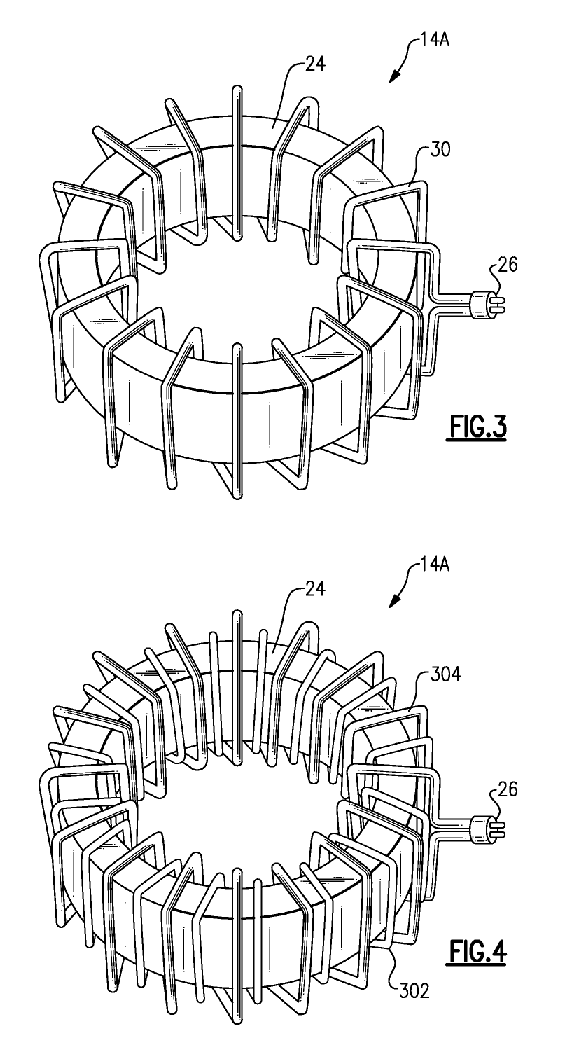

The three-phase inverter 10 has circuitry for phase A 12A, phase B 12B, and phase C 12C. Each of the phases 12 A-C is electrically connected to a corresponding single-phase interphase transformer 14 A-C through connectors 26 (also shown on FIGS. 3 and 4). Each of the three single-phase interphase transformers 14 A-C has more surface area than a single phase of an equivalent three-phase interphase transformer. The increased surface area is due to the fact that a three-phase interphase inverter has three phase windings wrapped around a single core and therefore has a smaller amount of exposed surface area. The increased exposed surface area per phase of a single-phase interphase transformer allows for faster and more efficient heat dissipation. This allows the three single-phase interphase transformers 14 A-C combined to be constructed smaller than a three-phase interphase transformer and thereby take up less weight and space.

The three single-phase interphase transformers 14 A-C operate in a similar fashion as a single three-phase interphase transformer. This allows the single-phase interphase transformers 14 A-C to be controlled by any system that could control a standard three-phase interphase transformer, and also allows the single-phase interphase transformers 14 A-C to perform the same functions as that of a three-phase interphase transformer.

Implementation of the three single-phase interphase transformer design has another advantage over the known use of a three-phase interphase transformer. Single-phase interphase transformer voltage stress is

$$\frac{1}{\sqrt{3}}$$

times that of a three-phase interphase transformer. That results in less insulation being required. The additional space around the interphase transformer's cores resulting from the use of single-phase interphase transformers instead of a three-phase interphase transformer allows additional number of winding turns to be added to maximize the capability of the single interphase transformer.

The heat winding 302 of one embodiment comprises a tube that is capable of conducting heat and also allowing a liquid or a gas to be contained within the tube. The heat winding 302 is wrapped around the core 24 (see FIGS. 3 and 4) of the single-phase interphase transformer 14A-C, along with the electrical winding 304, thus allowing the heat winding 302 to act in a similar capacity as the known heat sinks while occupying less space. An embodiment using separate heat windings 302 and electrical windings 304 is illustrated in FIG. 4. In such a construction the heat winding 302 and the electrical winding 304 are intertwined around the core 24 thereby allowing the heat winding 302 to absorb and dissipate heat generated in both the electrical winding 304 and the core 24. The illustrated embodiment of FIG. 4 also comprises an electrical connector 26 which connects the electrical winding 304 with the three-phase power inverter 10.

FIGS. 3, 5A, and 5B illustrate a combined heat/electrical winding 30 that could be used. FIG. 3 represents a simplified drawing of a single-phase interphase transformer 14A that could be used in the embodiment of FIG. 2. The single-phase interphase transformer is connected to the three-phase power inverter through electrical connector 26. Similar single-phase interphase transformers 14B, 14C would be used for the other two phases. The heat/electrical winding 30 of this embodiment comprises a tube wrapped around a core 24. The combined heat/electrical winding 30 should have at least one layer of electrically conductive material 32 (illustrated in FIG. 5A) or 34 (illustrated in FIG. 5B) such as copper, and a hollow center capable of containing a gas or a liquid.

In the embodiment of FIG. 5A heat is typically generated in the electrical portion of the winding 30 as well as the core 24, and the liquid inside the heat/electrical winding 30 absorbs the heat and is converted to a gas. The gas then condenses when it contacts the wall of the heat/electrical winding 30 and converts back into a liquid. This process is described in greater detail below. In this way the heat energy is dissipated in both the condensation and evaporation processes. It is additionally anticipated that a similar heat dissipation process could be performed where the heat winding 302 and the electrical winding 304 are separate windings (the embodiment of FIG. 4), which are both wound around a single core 24. It is additionally known that the liquid or gas could be sealed into the winding and dissipate heat through the state change described above, or be connected to a coolant fluid reservoir where the hot gases would flow, condense, and then be recycled through the heat/electrical winding 30.

Two cross sections of types of tubing that can be used for the combined heat/electrical winding 30 are disclosed in FIGS. 5A and 5B.

The first cross section (FIG. 5A) has a single electrically and thermally conductive layer 32 that can be connected to the three-phase power inverter 10, and thereby conduct electricity from the power inverter 10. By way of example, the tubing for the heat/electrical winding 30 could be at least partially made out of copper and comprise a wick structure according to known heat pipe techniques, although it is anticipated that other materials would be functional and still fall under this disclosure. A single layer embodiment (FIG. 5A) of the tubing for the heat/electrical winding 30 would allow the heat dissipation process described above. It is known that the single layer embodiment of FIG. 5A could have additional layers applied to its external surface and still meet the description of the single layer embodiment.

The second cross section (FIG. 5B) illustrated in FIG. 5 shows a heat/electrical winding 30 being constructed out of multiple layers, where the outside layer 34 is an electrically conductive layer, at least one of the interior layers 36, 38 is an electrically resistive layer, and all of the layers 34, 36, 38 are thermally conductive. Additionally, in one embodiment of FIG. 5B layer 38 comprises a wick structure of heat pipe, layer 36 comprises an electrical insulation layer, and layer 34 comprises copper for electrical conduction. This allows for the heat dissipation process described with the heat/electrical winding 30 of FIG. 5A to be utilized with the multilayer heat/electrical winding 30 of FIG. 5B, and additionally allows for an electrical isolation of the electrical portion of the winding 30 from the cooling liquid/gas.

It is anticipated that the multilayer embodiment of FIG. 5B could be constructed using only two layers 38, 34 or be constructed of more than three layers where at least one of the layers other than the inside layer 38 is constructed of an electrically conductive material, and each of the layers is constructed of a thermally conductive material. In an embodiment of the two layer construction, the inner layer 38 is constructed at least partially out of copper for electrical conduction, and the outer layer 34 comprises electrical insulation. In such an embodiment a vapor liquid slug flows inside the hollow wire creating an oscillation type heat pipe according to known heat pipe techniques.

FIG. 6 illustrates a partial cutout view of a heat/electrical winding 30 wrapped around a core 24. Additionally shown is a cold plate 106 contacting the portion 104 of the heat winding 30 which is farther away from the core. When electricity flows through the wall of the heat/electrical winding 30 the winding itself heats up as well as the core 24. The heat generated by the heat/electrical winding 30 and the core 24 is not distributed evenly over the surface of the heat/electrical winding 30. The cooler portion 104 will be where the winding 30 is attached to the cold plate 106. Heat conducted from heat winding 30 to the liquid inside the heat winding 30 will cause the liquid to evaporate and move up through the hollow portion of the heat winding 30, where it will come near the cold plate 106. As it is comes near the contact of the cold plate 106, which is relatively cooler, this liquid will condense and move downward via a wick inside the heat winding 30. Alternately a finned heat exchanger could be used instead of the above described cold plate and still fall under this invention. single-phase

The foregoing description shall be interpreted as illustrative and not in any limiting sense. A worker of ordinary skill in the art would recognize that certain modifications would come within the scope of this invention. For that reason, the following claims should be studied to determine the true scope and content of this invention.

What is claimed is:

1. A three-phase power inverter comprising;
three single-phase interphase transformers wherein each interphase transformer is connected to one phase of a three-phase power inverter; and
each of said three single-phase interphase transformers comprises at least one component for dissipating heat.

2. The inverter of claim 1 additionally comprising a connector being operable to connect three-phase power inverter inputs to an aircraft power generation system.

3. The inverter of claim 1 wherein said at least one component for dissipating heat comprises at least a heat winding.

4. The inverter of claim 3 wherein said single-phase interphase transformers comprise;
a core material;
a heat winding wound around said core material; and
at least one electrical connection connecting said three-phase power inverter with each of said three single-phase interphase transformers.

5. The inverter of claim 4 wherein said heat winding comprises a tube capable of containing a liquid or gas.

6. The inverter of claim 5 wherein said heat winding contains a liquid or gas, and wherein said heat winding dissipates heat using said liquid or gas.

7. The inverter of claim 6 wherein heat dissipation is accomplished through state transformation of said liquid or gas.

8. The inverter of claim 4 wherein each of said single-phase interphase transformers additionally comprise an electrical winding wound around said core material.

9. The inverter of claim 8 wherein said electrical winding and said heat winding on each phase comprise a single winding;
said winding having at least one surface capable of conducting electricity;
said winding being thermally conductive; and
said winding being capable of containing a liquid or a gas.

10. The inverter of claim 9 wherein said winding additionally comprises at least one connector per phase electrically connecting each phase of said three-phase power inverter to one of said three single-phase interphase transformers.

11. The inverter of claim 9 wherein said winding additionally comprises a tube.

12. The inverter of claim 11 wherein said winding contains a liquid or gas, and wherein said heat winding dissipates heat using said liquid or gas.

13. The inverter of claim 8 wherein said electrical winding and said heat winding on each phase comprise separate windings;
said heat winding being thermally conductive;
said heat winding being capable of containing a liquid or a gas; and
said electrical winding being electrically conductive.

14. The inverter of claim 13 wherein said heat winding is electrically resistive.

15. The inverter of claim 13 wherein said electrical winding additionally comprises at least one connector per phase electrically connecting each phase of said three-phase power inverter to one of said three single-phase interphase transformers.

16. The inverter of claim 13 wherein said heat winding comprises a tube.

17. The inverter of claim 16 wherein said heat winding contains a liquid or gas, and wherein said heat winding dissipates heat using said liquid or gas.
